(19) United States
(12) Patent Application Publication
(10) Pub. No.: US 2026/0264298 A1
(43) Pub. Date: Sep. 10, 2026

(54) LOW MOISTURE COMPOSITE MATERIALS INCORPORATING CARBON FIBERS AND CARBON NANOTUBES

(71) Applicant: Seagate Technology LLC, Fremont, CA (US)

(72) Inventors: Michael Yi Zhao Yao, Singapore (SG); Alvin Koh Soi Heng, Singapore (SG); Tsuny Ming Boh, Singapore (SG)

(21) Appl. No.: 19/550,943

(22) Filed: Feb. 26, 2026

Related U.S. Application Data
(63) Continuation-in-part of application No. 19/069,489, filed on Mar. 4, 2025.

(51) Int. Cl. B29C 45/00; B29K 23/00; B29K 509/00; B29L 17/00

(52) U.S. Cl. CPC B29C 45/0013; B29C 45/0001; B29C 45/0005; B29K 2023/00; B29K 2509/00; B29L 2017/00

(57) ABSTRACT

Disclosed are composite injection moldable and thermoformable materials that may be used for making carriers (such as trays, packaging, and so forth) for carrying, cleaning, storing, and/or shipping electronic components or devices, as well as to the carriers made from such materials. In accordance with various aspects, the materials may be composed of a cyclic olefin polymer and a hybrid filler that includes tuned amounts of carbon fibers and carbon nanotubes to achieve desired stiffness and ESD properties.

### CROSS REFERENCE TO RELATED APPLICATIONS

This application is a continuation-in-part of U.S. Patent Application No. 19/069,489 filed Mar. 4, 2025, which is hereby incorporated by reference in its entirety.

### TECHNICAL FIELD

This disclosure relates to composite materials that incorporate carbon fibers and/or carbon nanotubes as fillers.

### SUMMARY

In accordance with certain aspects, the present disclosure describes carriers for holding electronic components, the carriers composed of low moisture composite materials that include a cyclic olefin polymer resin, carbon fibers dispersed in the cyclic olefin polymer resin in an amount to provide a desired stiffness, carbon nanotubes dispersed in the cyclic olefin polymer resin in an amount to provide the carrier with a surface resistivity in the dissipative range.

In certain aspects, the carbon fibers are present in an amount of 5% to 20% by weight in the composite material, and/or may be present in an amount sufficient to achieve a flexural modulus for stiffness that is greater than about 10,000 MPa.

In certain aspects, the carbon nanotubes are present in an amount of 2% to 8% by weight in the composite material, and/or may be present in an amount sufficient to achieve a surface resistivity of about 1×10⁴ ohms to 9.9×10¹¹ ohms.

In accordance with certain aspects, the present disclosure further describes methods for making carrier trays for containing electronic components in a plurality of pockets, where such methods include blending a composite material composed of a cyclic olefin polymer resin, carbon fibers dispersed in the cyclic olefin polymer resin, and carbon nanotubes dispersed in the cyclic olefin polymer, where the carbon fibers are present in an amount to provide a desired stiffness and the carbon nanotubes are present in an amount to provide a surface resistivity in the dissipative range. The blended composite may then be formed into a carrier tray, for example by injection molding or thermoforming.

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF THE DRAWINGS

FIG. 1A is a schematic illustration of an example carrier tray for electronic components, the carrier tray being composed of low moisture composite materials in accordance with aspects of the present disclosure.

FIG. 1B is a schematic illustration of multiple stackable carrier trays that are stacked together, the trays being composed of low moisture composite materials in accordance with aspects of the present disclosure.

FIG. 2A is a schematic top view of a carrier tray that may be formed from low moisture composite materials in accordance with the present disclosure.

FIG. 2B is a schematic side view of the carrier tray shown in FIG. 2A, taken along line 2B.

FIG. 2C is a schematic magnified view of the microscopic structure of a portion of the carrier tray of FIG. 2B that is indicated by area 2C, the carrier tray being formed from low moisture composite materials in accordance with the present disclosure.

FIG. 3 is a flow chart that depicts steps that may be performed in the blending of a low moisture composite material in accordance with the present disclosure, and in the formation of a carrier tray from such composite material.

### DETAILED DESCRIPTION

The present disclosure relates to low moisture composite materials and to electronic component carriers (also referred to as “carrier trays” or just “trays”) composed of such low moisture composite materials. In particular, such low moisture composite materials are made from a base resin of cyclic olefin polymer (also referred to as cyclo olefin polymers or COP) and include a hybrid filler containing carbon fibers (CF) and carbon nanotubes (CNT). The COP resin provides for a composite material containing low moisture and producing little to no outgassing. The hybrid filler containing CF and CNT provides enhanced mechanical properties such as stiffness and desirable electronic properties such as electrostatic discharge (ESD) performance.

The low moisture COP-CF-CNT materials of the present disclosure may be made into electronic component carrier trays by any suitable method such as thermoforming, injection molding, and the like. Such component carriers may be used to hold and transport components for hard disk drives (HDDs) during manufacturing and assembly. These include component trays for holding and transporting head stack assemblies (HSAs), actuator pivot flex assemblies (APFAs), head gimbal assemblies (HGAs), voice coil motor assemblies (VCMAs), and so forth. As used throughout this document, the terms tray, carrier, packaging, and the like may be used synonymously to refer to any type of component carrier that is designed for containing one or more components for transport between process stations, for shipping, for cleaning, for staging, for temporary storage, and so forth. It will be appreciated that the use of one such term is non-limiting and does not preclude other terms or other uses.

Conventionally, electronic component carriers have been made by injection molding a polycarbonate (PC) material that includes a glass fiber filler and an amount of carbon black for ESD protection, or by thermoforming polyethylene terephthalate modified with glycol (PETG). In accordance with the present disclosure, it has been observed that the PC and PETG base materials, which are both ester-type polymers, are prone to hydrolysis and can produce volatile organic compounds. These volatile organic compounds reside in and on the carrier trays made from PC and PETG materials, and can be transferred to the components held by the carrier trays. Incorporating components exposed to volatile organic compounds into HDDs can be detrimental to the operation and lifetime of the HDDs, particularly for HDDs that utilize heat-assisted magnetic recording (HAMR).

Moreover, the moisture content in PC and PETG can cause hydrolysis reactions in materials included in the electronic components being held by the carrier trays. PC has a typical moisture content of around 0.2% to 0.4%, or 2000 to 4000 parts per million (ppm), whereas PETG has a typical moisture content of around 0.4 to 0.6%, or 4000 to 6000 ppm. This relatively high moisture content can cause hydrolysis reactions in the acrylate-based structural adhesives and pressure sensitive adhesives that reside on HDD components such as HGAs and HSAs, thereby producing volatile organic compounds that can outgas inside an enclosed HAMR HDD, thereby causing operational issues related to carbonaceous residue. In contrast, using COP resins in accordance with the present disclosure can reduce moisture content by an order of magnitude or more. As used herein, COP includes any cyclic olefin polymer (that is, a polymer made from cyclic monomers) or copolymer (that is, a polymer produced by copolymerizing cyclic monomers with ethylene).

The fillers conventionally used in carrier tray materials can also cause issues in HDDs. In particular, carbon black particles, which are typically about 300 to 500 nm in diameter, are generally smaller than the leading edge opening between a recording head flying over spinning magnetic recording media disks in an HDD. As such, carbon black particles that may become dislodged from carrier trays and that may find their way from a component part into the interior of an HDD pose a risk of entering the head disk interface, which can lead to drive reliability. In addition, glass fibers may be shed from carrier trays and transferred to component parts and into HDD interiors, which can lead to scratches and other damage to HDD recording media disks.

Therefore, there is a need for low moisture, low outgassing materials that can be formed into carrier trays for electronic devices and that exhibit desirable stiffness and ESD properties without excessive shedding of particles or fibers that could cause damage or reliability issues inside an HDD. In accordance with various aspects, the present disclosure provides a composite material composed of a COP base resin and including a hybrid filler that combines tuned amounts of carbon fibers and carbon nanotubes to achieve desired properties.

As discussed, molded and thermoformed plastics are often used to make trays and carriers for transporting electronic devices and components. Filler materials may be used to impart certain characteristics and properties in the finished molded items, including reduced weight, increased strength or stiffness, sufficient surface conductivity to dissipate static and prevent ESD events, and so forth. In accordance with various aspects of the present disclosure, a combination of filler materials may be used that includes CFs present in an amount that imparts desired stiffness without leading to undesired brittleness and flaking, and that also includes CNTs present in an amount that imparts desired surface resistivity in the static dissipative range. By tuning the amount of CF for physical properties without reliance on the CF filler for electrostatic properties, and independently tuning the amount of CNT filler to impart desired electrostatic properties, the desired benefits of the filler materials can be realized without introducing deleterious effects such as surface flaking that may occur when CF and/or CNT are added in greater amounts.

In accordance with aspects of the present disclosure, it is recognized that, by blending a COP base resin with a hybrid filler that combines CFs with CNTs, the amount of CFs and the amount of CNTs can be individually tuned to provide different properties while at the same time reducing the total weight percentage of all fillers, thereby reducing the occurrence of surface peeling and flaking. For example, when molding a tray for carrying electronic components, CF and CNT can be added as fillers to COP to produce a desired target stiffness (for example, a flexural modulus greater than about 10,000 MPa), a target heat deflection temperature under load (for example, heat deflection temperature HDT of greater than about 180° C under 1.8 MPa load), and a target surface resistance range (for example, in a range of about 1×10⁴ ohms to 9.9×10¹¹ ohms). To accomplish this, the CF filler may be present in an amount from about 5% to 20% by weight, and the CNT filler may be present in an amount from about 2% to 8% by weight. These amounts represent a reduction from what may be used conventionally and thereby may result in reduced surface peeling and flaking. For the CF filler, long carbon fibers, short carbon fibers, milled carbon fibers, and combinations thereof may be used. For the CNT filler, various sizes of carbon nanotubes, graphene, carbon nanofibers, and combinations thereof may be used.

Moreover, it has been found that imparting a surface roughness to a molded material can reduce stiction between the molded carrier and the parts being carried, primarily by reducing the surface area over which the carrier and the parts are in contact. However, when CF is used as a filler material, the inclusion of CF within protrusions of the roughened surface structure can lead to flaking. As such, in accordance with various aspects, the present disclosure provides for imparting a surface roughness in a manner that prevents CF from entering the pockets that form the protrusions, thus producing material islands that are resin-rich and substantially devoid of CF, which leads to a decreased risk of surface flaking. This may involve imparting a surface roughness on the molded carrier having a characteristic dimension that is smaller than the average size of the carbon fibers in the CF filler.

Reference will now be made to the drawings, which depict one or more aspects described in this disclosure. However, it will be understood that other aspects not depicted in the drawings fall within the scope of this disclosure. Like numbers used in the figures refer to like components, steps, and the like. However, it will be understood that the use of a reference character to refer to an element in a given figure is not intended to limit the element in another figure labeled with the same reference character. In addition, the use of different reference characters to refer to elements in different figures is not intended to indicate that the differently referenced elements cannot be the same or similar. It will also be appreciated that the drawings are meant to illustrate certain aspects and arrangements of features in a way that contributes to their understanding and are not meant to be scale drawings that accurately represent size or shape of elements.

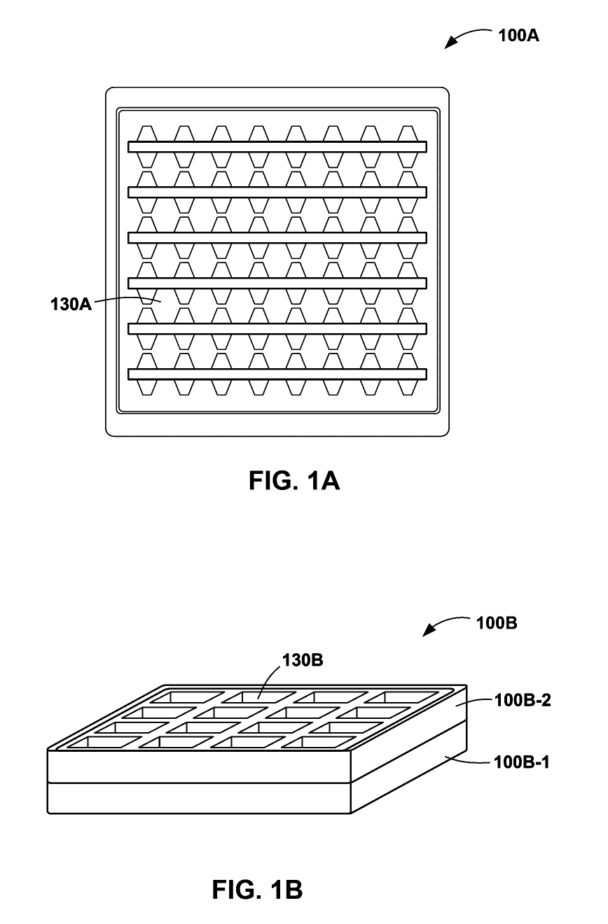

FIG. 1A is a schematic plan view illustrating an example carrier tray 100A for holding electronic components such as components for HDDs. Carrier tray 100A may be composed of low moisture COP-CF-CNT composite materials in accordance with aspects of the present disclosure, and may include a plurality or pattern of raised structures that form pockets 130A, which may also be referred to as depressions, cavities, compartments, slots, and so forth, that are shaped to hold, secure, or contain certain electronic components. FIG. 1B is a schematic perspective view illustrating an example carrier tray stack 100B for holding electronic components in pockets 130B, for example electronic components for HDDs. Carrier tray stack 100B is shown to include a first carrier tray 100B-1 and a second carrier tray 100B-2 that is stacked on top of first carrier tray 100B-1, for example in a nested fashion. Carrier trays 100B-1, 100B-2 may be composed of low moisture COP-CF-CNT composite materials in accordance with aspects of the present disclosure. FIGS. 1A and FIG. 1B are merely exemplary embodiments, and it will be recognized that many other carrier tray configurations are possible. Indeed, any carrier tray configuration capable of being formed from low moisture COP-CF-CNT composite materials in accordance with aspects of the present disclosure is contemplated.

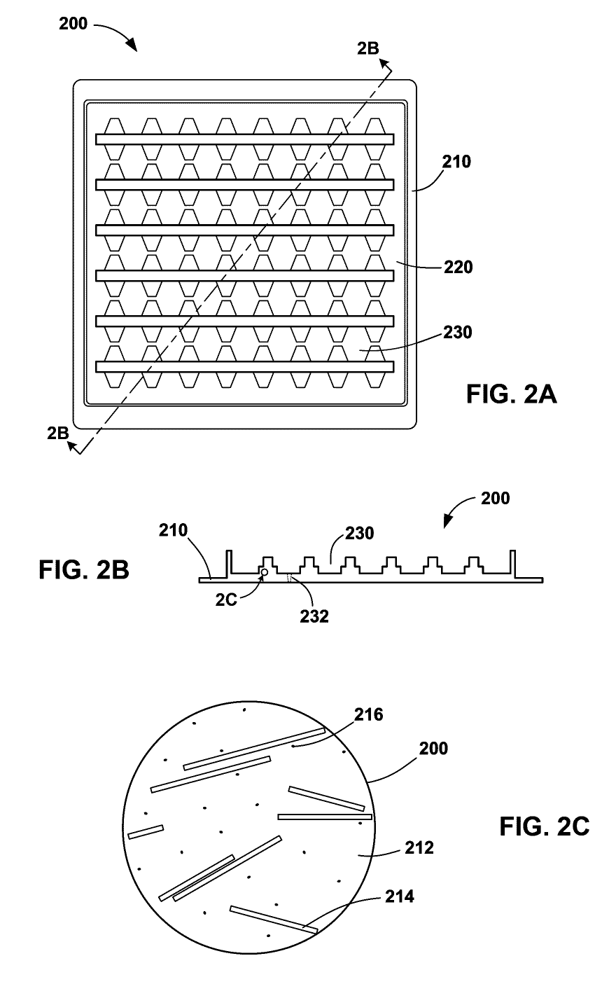

FIG. 2A is a schematic top view of an example electronic component tray 200 for containing electronic components. The tray 200 may be formed to have a base 210 and a raised carrier portion 220 that includes a plurality of pockets 230 that may be shaped to hold individual components. The tray 200 may be formed, for example by thermoforming or injection molding, out of a low moisture COP-CF-CNT composite material in accordance with aspects of the present disclosure. That is, the tray 200 may be formed from a composite of a COP resin, a CF filler present in an amount to provide a desired stiffness, and a CNT filler present in an amount to provide a desired surface resistivity.

FIG. 2B shows a schematic side view of tray 200 taken along line 2B in FIG. 2A, illustrating a possible configuration of the pockets 230 for holding electronic components. Pockets 230 are shaped to suitably contain the electronic components for the given application. Optionally, through holes such as through hole 232 may be formed in pockets 230, for example to facilitate the draining of liquid during washing processes, the application of vacuum suction, and so forth. It will be recognized that the dimensions of tray 200, including base 210 and pockets 230, are not to scale.

FIG. 2C represents a schematic illustration of the material of tray 200 at a microscopic scale, for example taken from the area of tray 200 that is marked as 2C in FIG. 2B. While not to scale, FIG. 2C illustrates that the material of tray 200 includes carbon fibers 214 and carbon nanotubes 216 dispersed in a matrix 212 composed of a COP material, which may be made from a single resin or a blend of resins, and which may include other additives and/or filler materials that are not indicated.

In certain embodiments, electronic component trays such as tray 200 may be used for containing hard disk drive (HDD) components. HDD component trays are typically either thermoformed trays, which are usually used once for shipment of components, or injection molded trays, which are rigid and more expensive than thermoformed trays and usually used for many cycles. Injection molded trays may often be used as shipment trays that are also used as process trays.

Injection molded trays are typically made of polycarbonate (PC) with carbon black and glass fibers added as fillers. As noted previously, PC-based trays (or alternatively, PETG-based trays) can retain moisture and can be prone to hydrolysis that can produce volatile organic compounds that are highly undesirable inside HDDs and HAMR HDDs. By using COP as the base resin, the moisture content is 0.01 to 0.02% (or 100 to 200 ppm), which is an order of magnitude less than the moisture content of conventional PC materials. As a consequence, the outgassing level of COP-based composite materials, and the carrier trays made therefrom, is very low. Moreover, COP-based carrier trays can be used continuously at higher temperatures than PC-based or PETG-based carrier trays without concern for contaminating electronic components.

The fillers added to composite materials for carrier trays are generally added to increase stiffness, increase tensile strength, improve heat deflection, improve electrical conductivity, and reduce costs (although glass fibers cannot improve electrical conductivity). As previously noted, high CF loading can result in peeling and flaking of resin, particularly in areas where accumulation of CF is at or near the surface. Such peeling and flaking may be more prominent after multiple uses, for example dozens to hundreds of use and washing cycles. Such peeling and flaking can cause component reliability issues, particularly when small flakes come off on the tray and onto the components when the components are placed in and removed from the tray. It should be noted that similar issues can appear with the use of other fillers.

As appreciated by the present disclosure, if only CFs are used as the filler for a COP resin in the formation of electronic component trays, then the amount of CF needed to impart the desired stiffness and achieve the target surface resistance will generally be in the range of 25% to 45% by weight. This relatively large amount can lead to carbon fiber bundling near the surface of the formed trays, which can result in peeling and flaking of resin. If only CNTs are used as the filler for a COP resin in the formation of electronic component trays, then the amount of CNT needed to impart the desired stiffness is high enough to result in a very low surface resistance, changing the material characteristics from dissipative to conductive. For certain electronic components that are ESD sensitive, contact with such a conductive surface while in the presence of an electrostatic field may cause an ESD event to occur that can damage the component.

Carbon fibers generally have sizes in the range of microns to tens or even hundreds of microns. Carbon fibers are made up of interlocking sheets of graphene and have a notably high tensile strength and stiffness. To create a carbon fiber composite material, carbon fibers are introduced into a melt that is composed of a polymer or polymer blend, such as an epoxy resin or other resin. The resulting mixture can be extruded, molded, thermoformed, and so forth, to create structures that may be useful as carriers, trays, and packaging. These composite materials are much stronger and stiffer than the polymer alone would have been.

Carbon nanotubes are cylindrical tubes of carbon atoms that are roughly 1000 times smaller than carbon fibers, having sizes on the order of nanometers to tens of nanometers. Nanotubes consist of carbon atoms bonded to one another in repeating hexagonal patterns to create a hollow cylinder that may be single-walled or multi-walled. Carbon nanotubes exhibit a high electrical conductivity, which makes them useful for electrical and electrostatic purposes. Carbon nanotubes also exhibit good thermal conductivity, which allows them to be used for heat transfer in polymers and other materials.

For ESD control, it is important for an electronic component tray or carrier to have a surface resistance that is in the dissipative range, which for the purposes of the present disclosure will be considered to be about 1×10⁴ ohms to about 9.9×10¹¹ ohms. Surface resistance in this range is sufficient to dissipate electrostatic charges when grounded. Below 1×10⁴ ohms is considered conductive, and above 1×10¹¹ ohms is considered insulative (although in certain aspects of the present disclosure, a surface resistance up to 9.9×10¹¹ ohms may be targeted).

In accordance with the present disclosure, CFs and CNTs are used as fillers for COP resins, with the CFs present in an amount tuned to provide sufficient stiffness and the CNTs present in an amount tuned to provide desired surface resistance. For example, 5% to 20% by weight of CF may be used in a COP resin to achieve sufficient stiffness, which may be defined in certain embodiments as having a flexural modulus greater than about 10,000 MPa. To achieve a surface resistance in the dissipative range, for example about 1×10⁴ ohms to 9.9×10¹¹ ohms, the CNT filler may be present an amount from about 2% to 8% by weight. In certain embodiments, these CF and CNT amounts may produce a heat deflection temperature of greater than about 180° C under a 1.8 MPa load while also exhibiting reduced peeling and flaking from the surfaces of finished carrier trays composed of the COP-CF-CNT material. With these properties, component trays made of these materials can stand repeated use, washing, and handling, including exposure to temperatures of 120°C.

Component trays may exhibit stiction between the surface of the trays and the components being contained. In certain applications, the surface of the trays may be roughened to reduce the amount of stiction. However, surface roughening can lead to increased peeling and flaking issues, particularly when CFs are used as a filler. The occurrence of peeling and flaking can be significantly reduced or eliminated by producing a surface roughness that creates resin rich islands, or protrusions, that are substantially devoid of CF. A surface roughness having dimensions that are less than the average size of the CF filler material will result in maintaining the CFs buried more deeply beneath the resin rich islands surfaces. The rough surfaces may be made by using electrical discharge machining (EDM) in the areas of the tray pockets to roughen the mold surfaces in areas where the components will have direct contact with the tray surface.

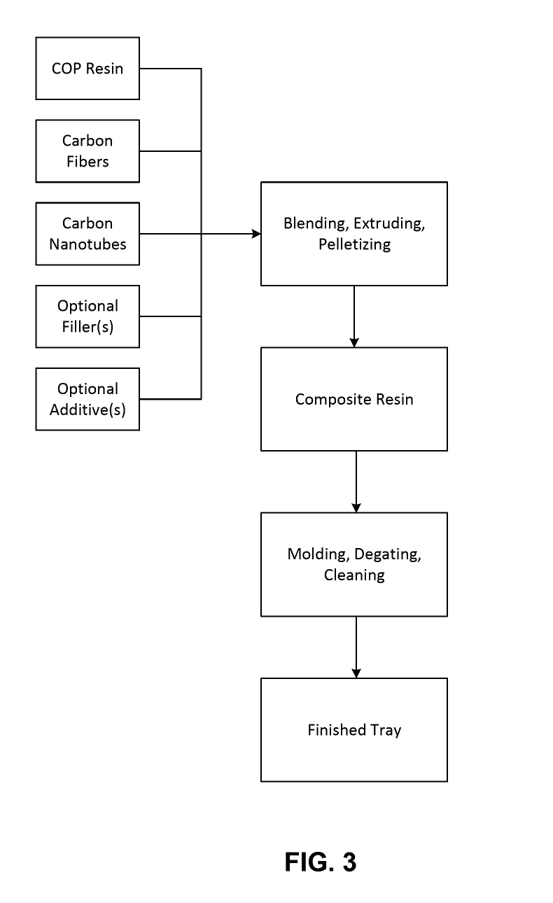

FIG. 3 shows a flow chart that includes steps that may be performed in the blending of a COP resin in accordance with the present disclosure, and then using that resin to form a molded or formed item such as an electronic component tray. A COP base resin may be blended with carbon fibers and carbon nanotubes, and optionally with other fillers and additives. In certain embodiments, the blend may be extruded and pelletized so that the resulting composite resin pellets include carbon fibers present in an amount that provides a desired stiffness and carbon nanotubes present in an amount that provides a desired surface resistivity in the dissipative range. These pellets of composite resin can then be heated and molded, for example by injection molding, into the final shape of the finished component tray or other molded item. The molded item can be degated, cleaned, and so forth to produce the finished item ready for use. As described above, the mold used for molding the composite material may be imparted with a surface roughness that allows resin-rich islands to be formed that are substantially devoid of carbon fibers, thereby reducing or eliminating any peeling and flaking of resin due to surface structure.

It should be understood that various aspects disclosed herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (for example, all described acts or events may not be necessary to carry out the techniques). In addition, while certain aspects of this disclosure are described as being performed by a single module or unit for purposes of clarity, it should be understood that the techniques of this disclosure may be performed by a combination of units or modules.

All scientific and technical terms used herein have meanings commonly used in the art unless otherwise specified. The definitions provided herein are to facilitate understanding of certain terms used frequently herein and are not meant to limit the scope of the present disclosure.

As used herein, the term “configured to” may be used interchangeably with the terms “adapted to” or “structured to” unless the content of this disclosure clearly dictates otherwise.

As used herein, the term “or” refers to an inclusive definition, for example, to mean “and/or” unless its context of usage clearly dictates otherwise. The term “and/or” refers to one or all of the listed elements or a combination of at least two of the listed elements.

As used herein, the phrases “at least one of” and “one or more of” followed by a list of elements refers to one or more of any of the elements listed or any combination of one or more of the elements listed.

As used herein, the terms “coupled” or “connected” refer to at least two elements being attached to each other either directly or indirectly. An indirect coupling may include one or more other elements between the at least two elements being attached. Further, in one or more embodiments, one element “on” another element may be directly or indirectly on and may include intermediate components or layers therebetween. Either term may be modified by “operatively” and “operably,” which may be used interchangeably, to describe that the coupling or connection is configured to allow the components to interact to carry out described or otherwise known functionality. For example, a controller may be operably coupled to a resistive heating element to allow the controller to provide an electrical current to the heating element.

As used herein, any term related to position or orientation, such as “proximal,” “distal,” “end,” “outer,” “inner,” and the like, refers to a relative position and does not limit the absolute orientation of an embodiment unless its context of usage clearly dictates otherwise.

The singular forms “a,” “an,” and “the” encompass embodiments having plural referents unless its context clearly dictates otherwise.

As used herein, “have,” “having,” “include,” “including,” “comprise,” “comprising” or the like are used in their open-ended sense, and generally mean “including, but not limited to.” It will be understood that “consisting essentially of,” “consisting of,” and the like are subsumed in “comprising,” and the like.

Reference to “one embodiment,” “an embodiment,” “certain embodiments,” or “some embodiments,” etc., means that a particular feature, configuration, composition, or characteristic described in connection with the embodiment is included in at least one embodiment of the disclosure. Thus, the appearances of such phrases in various places throughout are not necessarily referring to the same embodiment of the disclosure. Furthermore, the particular features, configurations, compositions, or characteristics may be combined in any suitable manner in one or more embodiments.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the disclosure.

What is claimed is:

1. A carrier for holding electronic components, the carrier composed of a low moisture composite material that comprises:
a cyclic olefin polymer resin;
a first filler dispersed in the cyclic olefin polymer resin, the first filler comprising carbon fibers present in an amount to provide a desired stiffness; and
a second filler dispersed in the cyclic olefin polymer resin, the second filler comprising carbon nanotubes present in an amount to provide the carrier with a surface resistivity in the dissipative range.

2. The carrier of claim 1, wherein the first filler and the second filler are present in a combined amount that is insufficient to cause surface peeling or flaking from the carrier.

3. The carrier of claim 1, wherein the first filler comprises long carbon fibers, short carbon fibers, milled carbon fibers, or a combination thereof.

4. The carrier of claim 1, wherein the second filler comprises single-walled carbon nanotubes, multi-walled carbon nanotubes, graphene, carbon nanofibers, or a combination thereof.

5. The carrier of claim 1, wherein the first filler is present in an amount of 5% to 20% by weight in the composite material.

6. The carrier of claim 1, wherein the first filler is present in an amount sufficient to achieve a flexural modulus for stiffness that is greater than about 10,000 MPa.

7. The carrier of claim 1, wherein the second filler is present in an amount of 2% to 8% by weight in the composite material.

8. The carrier of claim 1, wherein the second filler is present in an amount sufficient to achieve a surface resistivity of about 1×10⁴ ohms to 9.9×10¹¹ ohms.

9. The carrier of claim 1, wherein the first filler is present in an amount of no more than 20% by weight, and the second filler is present in an amount of 2% to 8% by weight.

10. The carrier of claim 1, wherein the carrier has a heat deflection temperature of greater than about 180°C at 1.8 MPa.

11. The carrier of claim 1, wherein the carrier has a flexural modulus for stiffness that is greater than about 10,000 MPa.

12. The carrier of claim 1, wherein the carrier tray has a surface resistivity of about 1×10⁴ ohms to 9.9×10¹¹ ohms.

13. The carrier of claim 1, further comprising a plurality of pockets for holding the electronic components.

14. The carrier of claim 13, wherein the pockets have roughened surfaces characterized by resin-rich islands that are substantially devoid of carbon fibers.

15. The carrier of claim 13, further comprising a plurality of through holes, each of the through holes extending from one of the plurality of pockets to an exterior surface of the carrier.

16. The carrier of claim 15, wherein the through holes are configured to facilitate draining of liquid during washing of electronic components contained in the pockets.

17. The carrier of claim 15, wherein the through holes are configured to facilitate vacuum suction of electronic components contained in the pockets.

18. A method for making a carrier tray for containing electronic components in a plurality of pockets, the method comprising:
blending a composite material comprising a cyclic olefin polymer resin, a first filler dispersed in the cyclic olefin polymer resin, the first filler comprising carbon fibers present in an amount to provide a desired stiffness, and a second filler dispersed in the cyclic olefin polymer resin, the second filler comprising carbon nanotubes present in an amount to provide a surface resistivity in the dissipative range; and
forming the blended composite material into the carrier tray.

19. The method of claim 18, wherein the step of forming comprises using a mold having a roughened surface, the roughened surface configured to impart resin-rich islands on surfaces of the plurality of pockets.

20. The method of claim 18, wherein the first filler is present in the composite material in an amount of about 5% to 20% by weight, and the second filler is present in the composite material in an amount of about 2% to 8% by weight.
